(19) United States
(12) Patent Application Publication
(10) Pub. No.: US 2012/0030125 A1
(43) Pub. Date: Feb. 2, 2012

(54) Method and system for tracking,archiving, reporting, and communication of time, activity, and event details

(76) Inventor: ArunKumar RamaKrishnanNair, Plano, TX (US)

(21) Appl. No.: 13/134,033

(22) Filed: May 26, 2011

Related U.S. Application Data
(60) Provisional application No. 61/349,207, filed on May 28, 2010.

(51) Int. Cl. G06Q 10/06

(52) U.S. Cl. 705/319

(57) ABSTRACT

A method and system for time, activity, event tracking includes providing an application or portal or website over wireless or wired networked devices or systems, having means that allow users to keep information about all their activities and allow detailed reporting. The system also provides a plurality of tracking, archiving, reporting, communication, and management over various formats depending on user profile. The system provides services like compensate and certify user activities for personal or organizational goals and communicate and campaign about activities or promotion of products, ideas, and services. The method further includes storing user data in ranges, archiving, summarizing, aggregating of data, and using user profile and requests to initiate internal and external communication based on user profile. The method and system manage hierarchy of organizations, users; provide administrative functions over a plurality of external devices, applications, systems, media formats, websites, social media sites, and communication interfaces.

### CROSS-REFERENCE TO RELATED APPLICATIONS

Provisional application No. 61/349,207 filed on May 28, 2010.

### FEDERALLY SPONSORED RESEARCH

None

### SEQUENCE LISTING

None

### BACKGROUND

This relates to method and system for time and activity tracking having means that allow users to keep details of all their activities and events and reporting based on their inputs. Time and activity can be tracked using hand written notes or spreadsheets. There is no means of archiving and reporting the historical activities, verification of the activities, and communicating reports based on the activities over wired and wireless devices and to external systems or applications or social media portals or other electronic and non-electronic means.

There are some time entry systems that keep track of employee activity information for a certain time frame and are then discarded. When the activity is for an unpaid or voluntary service, it is usually never recorded. When a person or organization needs a summary or report of activities done over a period of time in the past, there is no means to get that information easily. The prior activity is not verified or recorded anywhere with authenticity of the information, for use after a few months or years. There is no easy means of providing aggregate information of personal or organizational activities and transmit the information over electronic systems or applications or social media portals for soliciting new members, advertising purposes, reporting, personal communication, for record keeping, and for any purposes.

Many individuals need the time and activity reports in verified or unverified formats to communicate their past activities and experiences over a period of time for educational, career, personal interests or opportunities. Individuals will also need to interact with other individuals or organizations based on various categories of activities. Similarly, organizations need a system for tracking member or volunteer or people's activities, interacting with them in various formats, creating reports of activities, events, and issuing certificates or reports based on the time, activity, event entries. Many of these activities and events may occur in places where there will not be any device or system available to properly track, record, and communicate the information. Organizations also need a means to track the donors that support them and charities or recipients that get services from them, interact with users or members, and report on various activities and events.

In conclusion, insofar as I am aware, no method and system for time and activity tracking, developed provides tracking, archiving, reporting, communication, and campaigning for users or organizations over various devices, systems, applications, and media formats over wired and wireless networks.

For the foregoing reasons, there is a need for a method and a system that can be used by individuals and organizations to track the time spent on activities and events, and archive, report, communicate, and campaign based on the information over various devices, systems, applications, and media formats over wired and wireless networks or other means.

### SUMMARY

An improved method and system for time and activity tracking, archiving, reporting, communication, and campaigning is developed for users or organizations to use over various types of computing devices, systems, applications, and media formats over wired and wireless networks. The method and system will keep track of all activities with details and verification if provided, archive the older information to summary, and schedule, report or communicate the information over various devices, systems, applications, and media formats. The users will receive communication from other users or organizations depending on their user profile. The system has means to manage organizations, users, their interactions in various forms, and the system will send reports with verification of time and activity entered for users for many purposes including education, employment, service recognition, or as means to communicate that information to others in any form.

### DRAWINGS—FIGURES

FIG. 1 is a functional block diagram of a globally-accessible system for logging into the system, tracking the time, activities, duration, event details, reporting and other requests. Refer “MTS_Fig1.pdf” for FIG. 1.

FIG. 2 is a functional block diagram showing the processing of data fields entered into the system, and related events. Refer “MTS_Fig2.pdf” for FIG. 2.

FIG. 3 is a functional block diagram of the administration of the system for managing various tasks. Refer “MTS_Fig3.pdf” for FIG. 3.

FIG. 4 shows the summary report for an individual using the system. Refer “MTS_Fig4.pdf” for FIG. 4.

FIG. 5 shows the detailed report for the sample summary report in FIG. 4. Refer “MTS_Fig5.pdf” for FIG. 5.

FIG. 6 shows a sample customized certificate generated by the system. Refer “MTS_Fig6.pdf” for FIG. 6.

FIG. 7 shows a summary report of an organization. Refer “MTS_Fig7.pdf” for FIG. 7.

FIG. 8 shows a departmental level summary report of an organization. Refer “MTS_Fig8.pdf” for FIG. 8.

### REFERENCE NUMERALS

110 user access the application or portal or website
120 user logs in
130 verify if user is registered already
140 register a new user, set personal profile
160 new activity and time to be entered by manual or electronic or automatic means
180 send reports as per user request
250 user activity
260 automatic collection of data
300 new activity, time of activity, and duration of activity with comments and related information
310 new activity, time of activity, and duration of activity with comments and related information to be verified
320 communication or message sent to supervisor or manager or authority for verification
330 Supervisor approve or disapprove information with any comments
350 data is marked as approved or verified
340 data is marked as unapproved or unverified
360 data checked for voluntary/paid service
370 new activity, time of activity, and duration of activity with comments and related information sent for payroll processing
190 new activity, time of activity, and duration of activity with comments and related information is stored in database organized by different ranges
380 data is checked for archiving
400 data is summarized and archived
200 user information is checked for visibility as per profile
220 user information is made visible as per profile
210 user information is kept confidential as per profile
230 publish reports as per profile
240 communication from other users
410 send system remainders to user
600 sample summary report
605 sample user
610 organization affiliation
620 recipient of report
625 summary information
630 annual summary per activity
640 aggregate information
650 verified information
700 detailed report
750 sample certificate
800 organizational summary report
810 organizational information
840 departmental information

### DETAILED DESCRIPTION

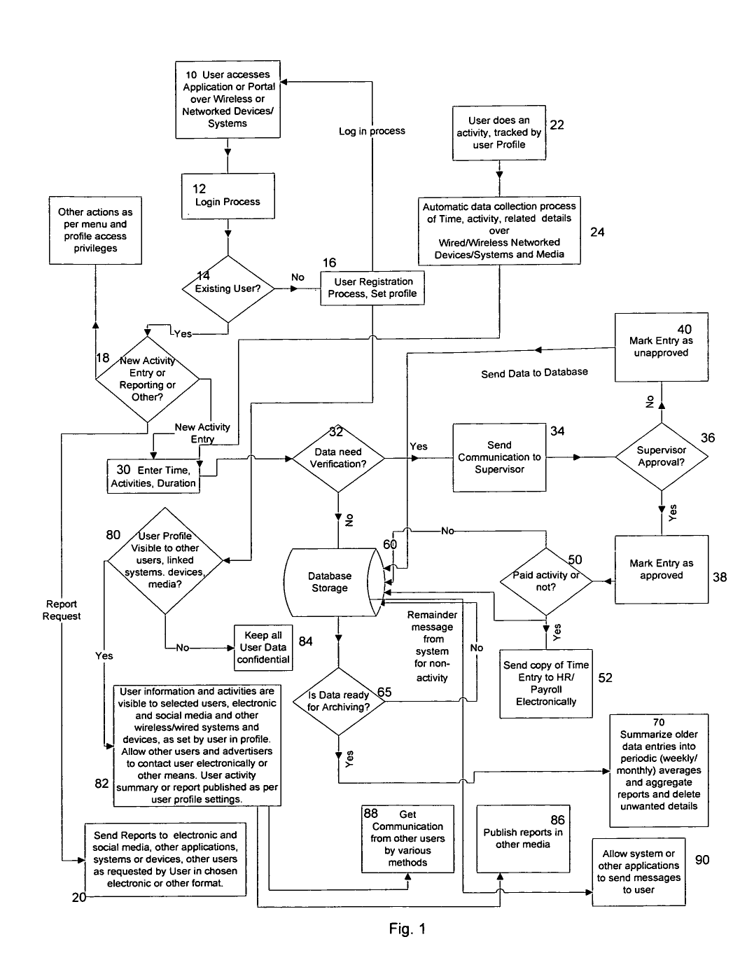

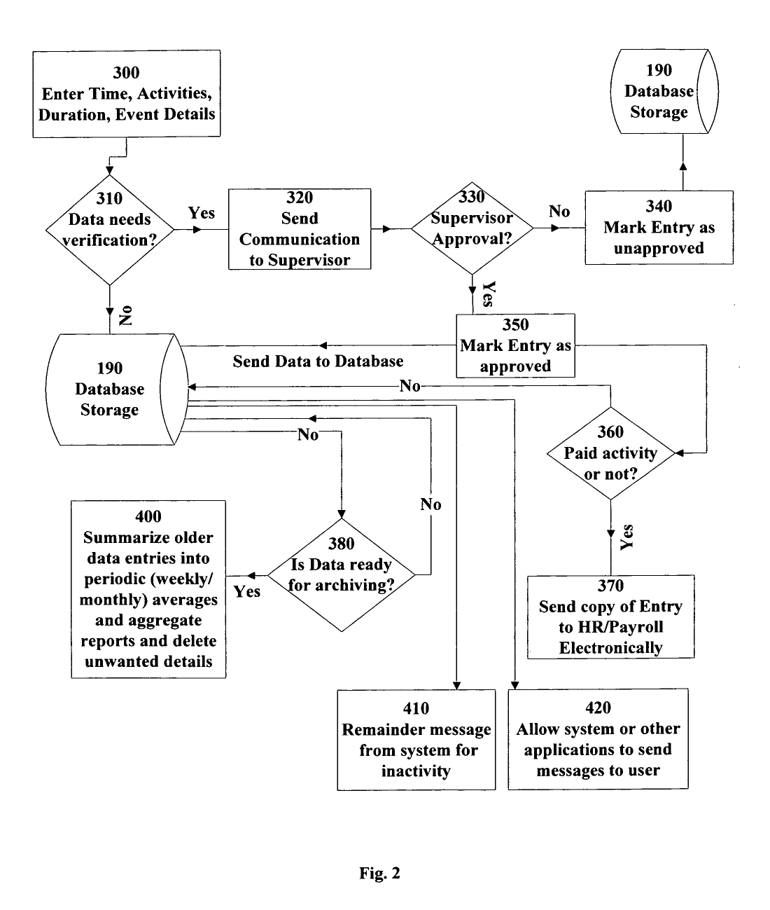

FIG. 1 is a schematic workflow of method and processes involved in the system for login process, campaigning, and reporting for end-users. FIG. 2 is a schematic workflow of method and processes involved in the system for tracking, archiving, communication, and reporting processes for end-users. User accesses the application or portal or website 110 over wireless or wired networked devices or systems or mobile communication devices or systems or applications. User logs in 120 by providing username and password or other identifiable credential, if already registered 130 or register as a user 140 and set the personal profile. The information requested for registration process may include:

### General Information:

First Name
Last Name
Gender
Birthday
Country
State
Primary Email Address
Recovery Email
Create Password
Enter Your Password Hint
Referred by
Security check
Security Question and answer
Occupation
Institution
Institution URL
Address
City
Zipcode
Are you Employed
Current Employer
Member photo
Activity Reminder Alerts:
   Every 5 days, Every 7 days, Every 10 days, Every 14 days, Every 21 days
Member Profile Visibility: Please select how your profile should be visible to other members
   All members of MyTimeScore
   All member of MyTimeScore has chosen any of your favorite activities
   All members of you organization (School/College/University/Company)
   All members from your state, who has chosen any of your favorite activities
   All members of your country, who has chosen any of your favorite activities
   I would like to keep my profile private for the time being

If a new activity or event is to be reported by manual 160 or electronic or automatic means 260, that information (new activity, data and time of activity, duration of activity, event details with comments and related details) is entered 300. The information requested for activity submission process may include:

### Activity/Event Details:

Activity Type—Volunteer or Paid
Department
Supervisor's Email ID
HR Email ID
Grade Level Select One—1 2 3 4 5 6 7 8 9 10 11 12 College No Grade
Select Category
Select Activity
Description
Position/Honors
User Comments
Venue Details
Rental Details
Equipment Details
Stationary Details
Skills Used
Food Expenses
Tools Expenses
Transportation Expenses:
Labor Expenses
Need verification
Number of people affected
Measure of change
Trees saved
Sustainability report
Carbon Footprint
Social Impact

If the data has to be verified 310, a communication or message 320 will be sent to supervisor or manager or authority to verify it. Supervisor or Manager or authority can approve or disapprove information 330 and add comments to the information that is getting verified. If the information is not verified or unapproved by the supervisor 340, it is stored in the system as unverified with or without any comments to database 190. If the information is verified or approved by the supervisor 350, it is verified as payment or voluntary service 360. If the approved information relates to a payable activity for the user, that will be communicated to the Human Resources or Payroll or related department/personnel electronically or other means 370. If it is an unpaid activity, it is stored in the system as unverified with any comments to database 190. Data is organized by different ranges in the database 190.

If the user does an activity 250, which is in the list of activities as per user profile, activity and related details will be automatically captured 260 and sent as new activity 300 to the system.

If the user sets his profile 140 for certain or all information to be visible to other users or a set of predefined group of users or systems or devices or media 230, that information will be communicated to the predefined group 220, as per user preferences 140. If the user as elected to keep all details confidential, details will be kept as confidential information 210. If the user elects to receive communication 240 from other users or selected group of users, user will receive messages 180. User may publish reports in other media 230 as per profile.

The system or other applications will send periodic messages or remainders 410 to user based on user preferences and profile 140. If the user wants to send a report or communication to other systems or users or devices, user will enter details of receiving entity and submit a request 180. The system can also exchange information to other systems in electronic formats or social media or other media formats depending on user profile. The system can send data to a plurality of external devices, applications, systems, media formats, websites, social media sites, and communication interfaces.

When the data in the system gets older, it is verified as candidate for archiving and sent to archiving 380. Archived data, outside of normal retention period of system, will be stored as summary information 400.

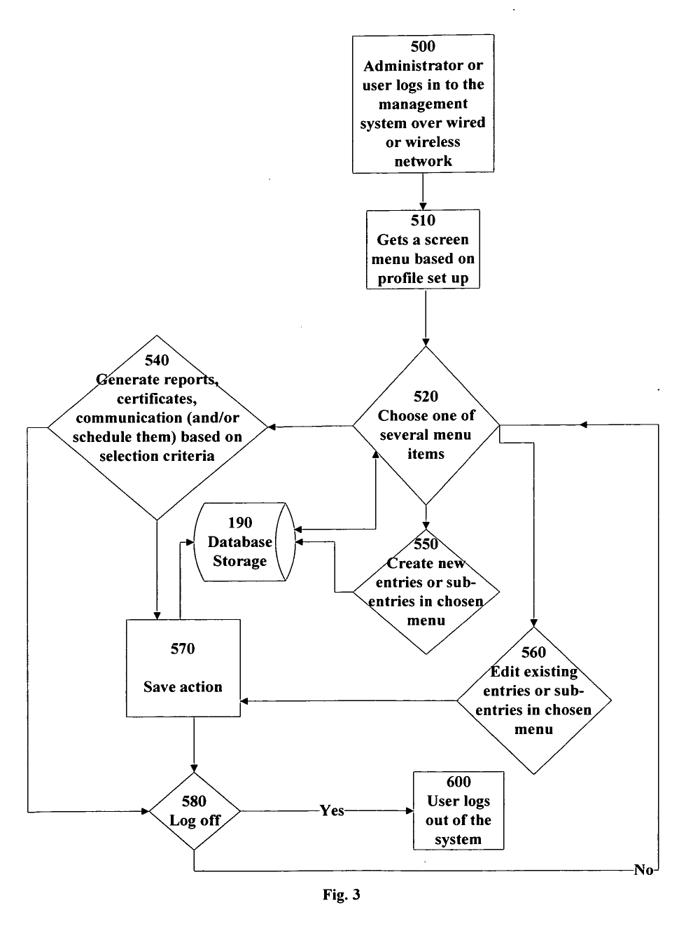

FIG. 3 is a schematic workflow of method and processes involved in the administrative system for managing administrators, users, login processes, organizations, sub-organizations, categories, activities, events, campaigning, reporting, various communication methods and other means.

Various levels of users which may be Super-administrator or administrator or sub-administrators will use this system for managing the various functions of the system. The user accesses the administrative module of the application or portal or website 500 over wireless or wired networked devices or systems or mobile communication devices or applications. User logs in 510 by providing username and password or other identifiable credentials. The user gets a personalized screen and menus based on profile in database 190 which may be defined by user profile and access privileges. The menu may include information on organizational levels, different categories and activities, billing information, charity, donor, and member information, users, reporting methods, methods to communicate or campaign, issue certificates, scheduling tools, discussion forums, polls, emails. The information requested for activity submission process in different menus may include:

### Organization Details:

Organization Name
Address
City
Zip Code
Country
URL
Telephone Number
Primary Email
Secondary Email
Company Tax ID
Administrator Details
User Id
Password
Admin Name
Email
Telephone Number
Contact Name
Contact Title
Contact Telephone Number
Contact Cell phone Number
Contact Fax Number
Contact Email
Currency

### Billing Details:

Contact Name
Contact Title
Contact Telephone Number
Contact Cell phone Number
Contact Fax Number
Contact Email
Address
City
Zip Code
Country
Logo
Enable Email Contact For End User
Enable Login For End Users
Max Number of Users
Sub Org Enroll Date
Sub Org Billing Type
Service Type
Other Fields

### Charity or Donor

Charity Description
Donation Description

### Event Details

Number of people affected
Measure of change
Trees saved
Sustainability report
Carbon Footprint
Social Impact

The information requested for user registration process may include information used in 140 and activity submission may include information used in 300. The reports and certificates may include information used in 140 and 300 and mathematically derived values from different information in the system in various formats.

The user can create 550, edit 560 or generate new and existing information and may include actions related to the various administrative tasks and save them 570. The user can log off 580 if desired and exit the system 600.

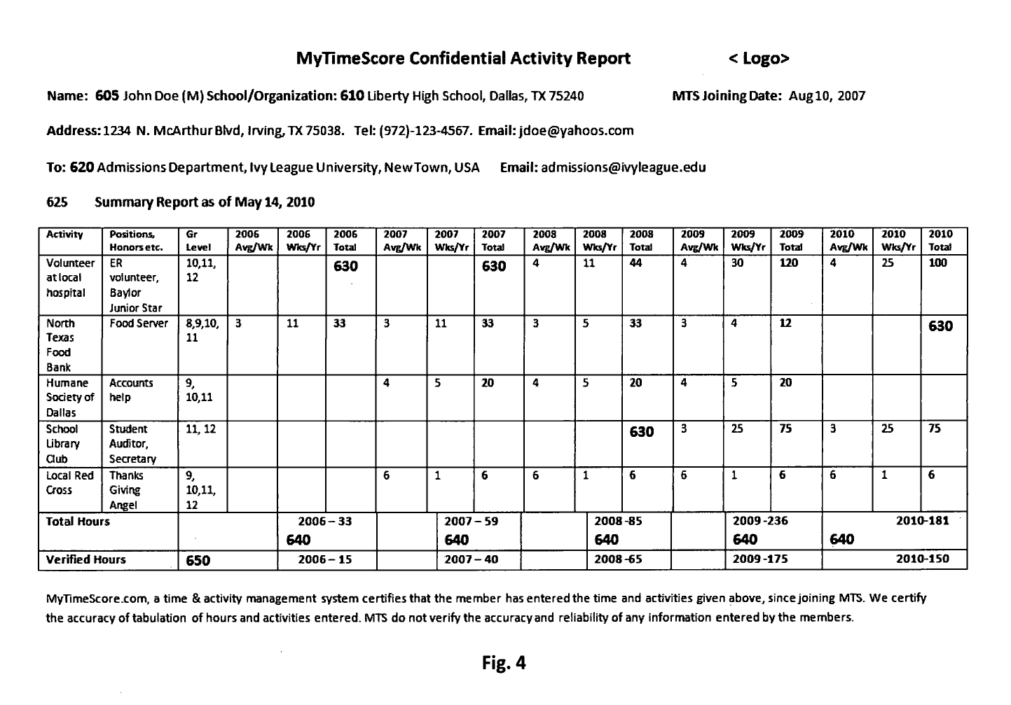

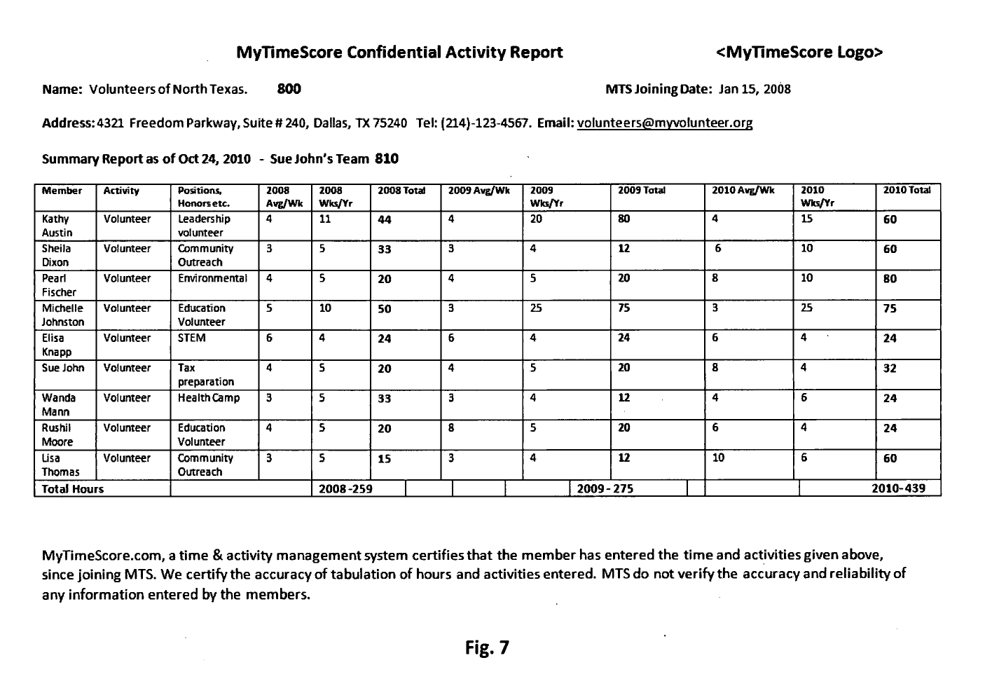

FIG. 4 is a sample report of a user 600, who is a high school student 605, who wants to use the system to send a report to the College Admissions Counselor 620. The same report or a similar may be sent in electronic file format or any media format to a recipient, requested by the user. FIG. 7 is a similar report created for adult users or employees of an organization 800 sorted by organizational team 810 communicated in any format to other recipients or systems or media formats.

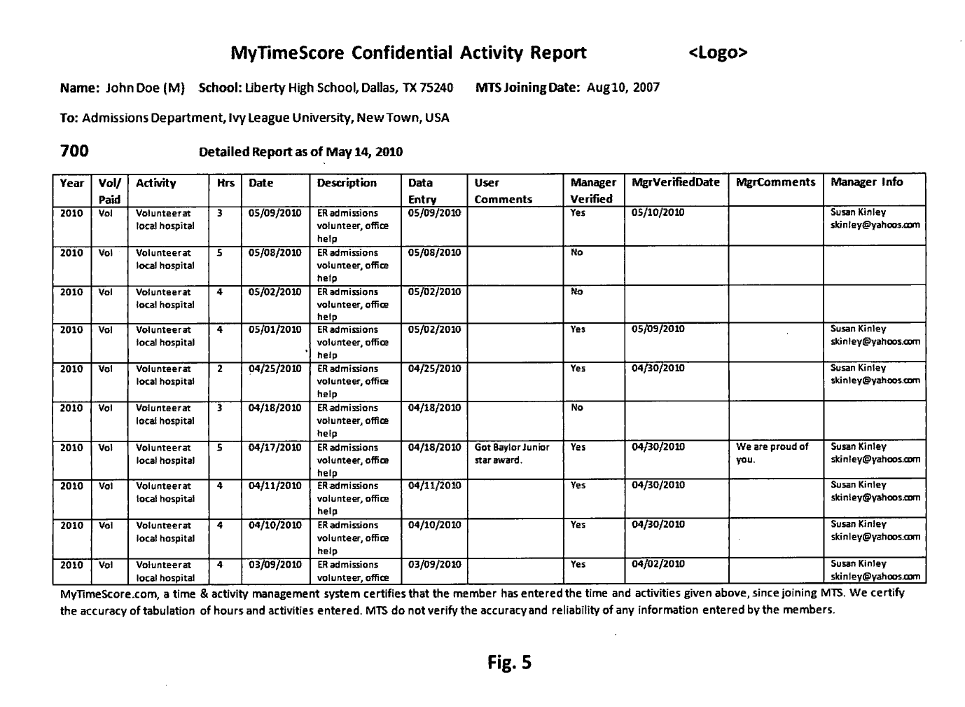

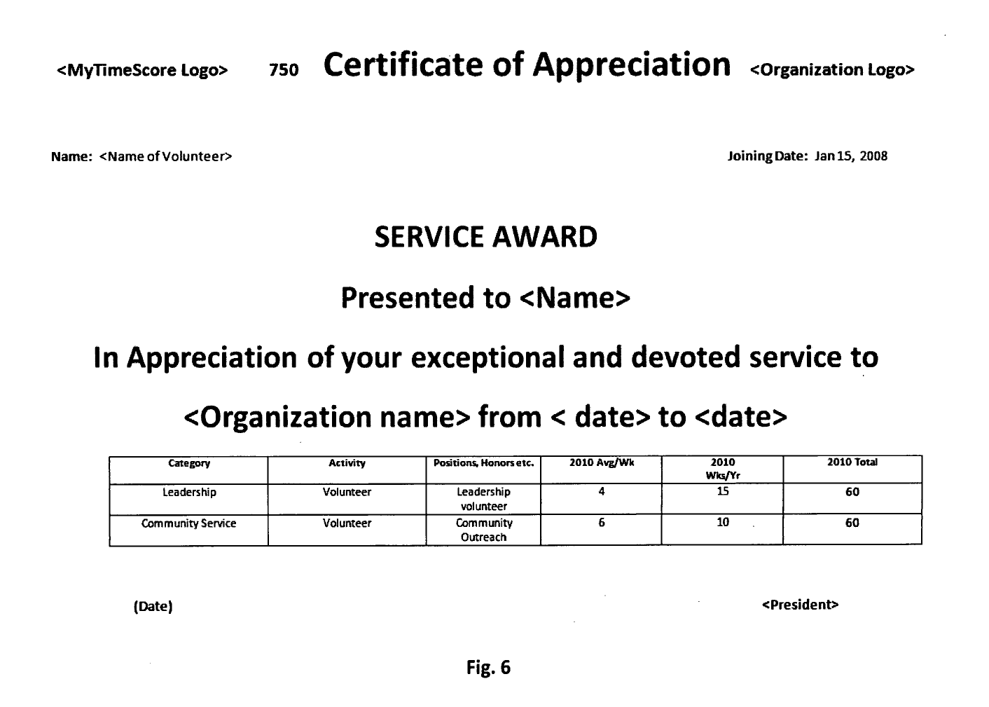

Any report can be created in any summary 600 format or detailed format 700 or as a Certificate 750 (FIG. 4, FIG. 5, FIG. 6) 116 using stored information and sent to any user or entity, as requested by user 605.

FIG. 5 shows the detailed report for the sample report in FIG. 4.

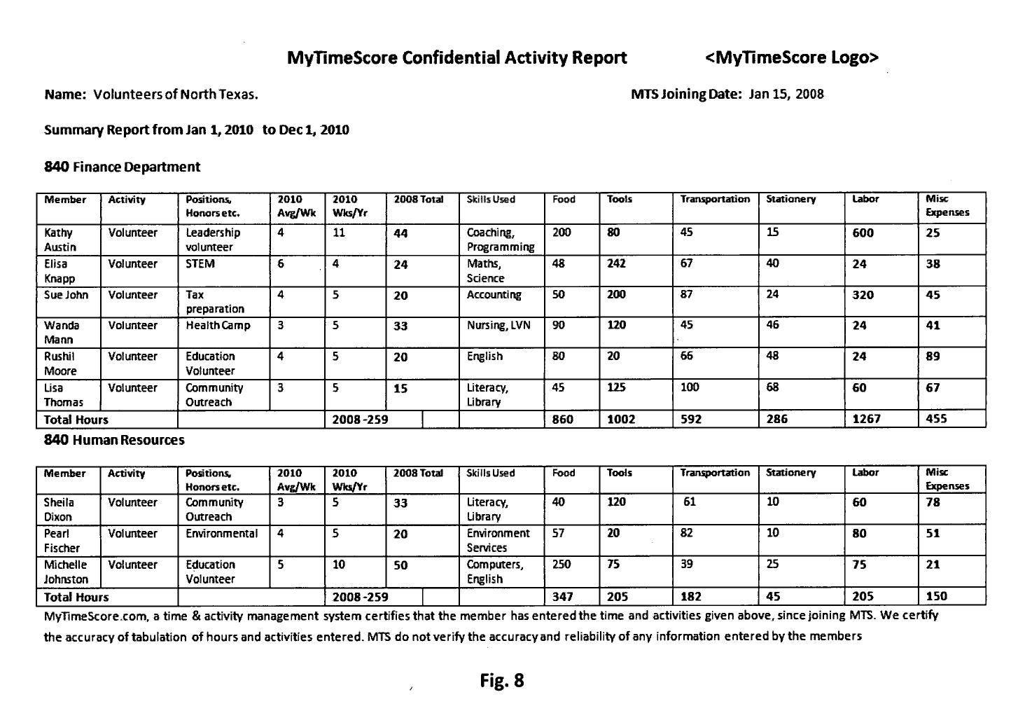

FIG. 8 is a similar report created for adult users or employees of an organization 800 sorted by department 840 communicated in any format to other recipients or systems or media formats.

### Operation—FIGS. 1, 2, 3

In operation, user accesses the application or website or portal or system over wireless or wired networked devices or systems, including all types of computing, communication, handheld and mobile devices, and related applications. User logs in or registers as a user and sets the personal profile. When a new activity is entered by manual or electronic or automatic means, it is checked for verification necessity. If it has to be verified, a communication or message will be sent to supervisor or manager or authority to verify it. If the supervisor does not verify or approve the data, it is stored in the system as unverified with any comments. If the data is approved by the supervisor, it is verified for payment. If it relates to a payable activity for the user, that will be communicated to the appropriate department. If it is an unpaid activity, data is stored in the system as unverified with any comments.

User can publish information including reports in various formats or initiate contact with others including users, systems, devices, and media as per user preferences in the profile. The system will send periodic messages to user based on user preferences and profile. If the user wants to send a report or communication to other systems or users or devices or media, user will enter details of receiving entity and submit a request.

When the data in the system gets old, it is sent to archiving, based on preferences. Archived data will be stored as summary information.

The administrative section of the application comprises of various means to control the different organizations and users in them based on hierarchy levels and different options to do various tasks which may include track, report, campaign, recognize, and communicate with members. The system supports various countries, states, regions, and currencies of the world and the user with the highest privileges can set the profile of other users based on various parameters.

What is claimed is:

1. A method and system for time, activity, and event tracking, archiving, reporting, communication, and campaigning for users and organizations comprising use over a plurality of computing devices, systems, applications and media formats over wired and wireless networks, comprising:
an user interface means for enabling the user to register, set up profile, and access the computing system, and
access means comprising an application, portal, website, system using a plurality of wireless and wired devices and systems including mobile communication devices for receiving information related to the activity and including updating the plurality of data fields based on information
whereby the user may update the plurality of data fields including activities, event details and time regularly, may get the said data verified or authenticated by supervisor or manager, may control communication of user information to other users based on a personal profile, may request reporting to other users or systems or applications or media or websites.

2. The method of claim 1, wherein comprises a process to verify the retention period of data entered for each user, or collected automatically from user by manual or electronic or automatic means and means to archive the data to summary reports outside of predefined retention period.

3. The method of claim 1, wherein the user's profile may be configured comprising restricted visibility by other user or systems or for communication by other users or systems.

4. The method of claim 1, wherein the user may request communication from the system to other users or systems with audited report of user activities verified by the system or other systems, supervisor, or personnel.

5. The method of claim 1, wherein the user may pay for using system services which may include validating user experiences and involvement in activities over a period of time.

6. The method of claim 1, wherein social, professional, or user groups may be formed comprising of users or organizations with similar profiles and inviting other users to join over a plurality of external devices, applications, systems, media formats, websites, social media sites, and communication interfaces.

7. A method and system for management, communication and campaigning for users or organizations to use over a plurality of devices, systems, applications and media formats over wired and wireless networks, comprising:
a means of managing including administrative functions for a plurality of hierarchies, organizations, users, categories, activities, events, campaigning, reporting, various communication methods,
a means of plurality of organizations, advertisers, and users to communicate and campaign to others including users, systems, applications about activities or promotion of products, ideas, services, and
a means to control the communication based on user preferences including geography, age group and other profile parameters or related criteria.

8. The method of claim 7, wherein the organizations and advertisers may pay for using the system for communication including advertising, campaigning, activities or promotion of products, ideas, services, based on user preferences.

9. A method and system for time, activity, and event reporting, authentication, and verification for users or organizations to use over a plurality of devices, systems, applications and media formats over wired and wireless networks, comprising:
a means of organizations to report a plurality of data fields including activities of their members or users and time spent, and
a means of compensating users for any payable activities, and
a means of recognizing or giving awards to users based on time spent on activities or plurality of data entered, and
a means of certifying including that user data was entered, authenticated, and verified in a timely manner over a plurality of processes,
whereby the user records may be verified including processed on a certain date or not updated or altered after they are stored in the system, to ensure the accuracy and authenticity of data kept in the system.

10. The method of claim 9, wherein the users or organizations may pay for using specialized reports to validate and support user experiences, activities or involvement including applying for educational, employment, career enhancement, scholarship or grant application, recognition purposes or any time reporting activities or related goals.
